(19) United States
(12) Patent Application Publication
(10) Pub. No.: US 2010/0175031 A1
(43) Pub. Date: Jul. 8, 2010

(54) DISCOVERY OF MEDIA CONTENT VIA USER INTERFACE

(75) Inventors: Benjamin Alton, Seattle, WA (US); Patrick Nelson, Seattle, WA (US); Kimberly Anne Ingraham, Kirkland, WA (US); Chad Roberts, Snohomish, WA (US); Hui Wang, Bellevue, WA (US); Thomas Clement Pease, North Bend, WA (US); Rochelle Benavides, Seattle, WA (US); Sean Rooney, Seattle, WA (US); Aleksandr Burba, Seattle, WA (US); Jason Aaron Gold, Seattle, WA (US); Kort Sands, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/350,890

(22) Filed: Jan. 8, 2009

(51) Int. Cl. G06F 3/048

(52) U.S. Cl. 715/841

(57) ABSTRACT

Embodiments related to facilitating the discovery of media content are disclosed. For example, one disclosed embodiment provides a method for displaying information related to media items in a graphical user interface. The method includes displaying one or more available media items in a view of the graphical user interface, and displaying a control operable to display an exploratory overlay related to a media item. The method further comprises receiving a user selection of the control for a selected media item, and in response displaying the exploratory overlay, the exploratory overlay includes a visual representation of the selected media item and visual representations of a plurality of related media items that are related to the selected media item.

### BACKGROUND

As digital media has grown in popularity, the quantity of available digital media content has become substantially large. So much so, that it has become increasingly challenging for users to find new content of interest. In some cases, users may turn to social networks to find digital media. For example, a user may discover new music from the collections or recommendations of their friends through listings on social networking websites. Subsequently, the user may have to navigate to a separate music website or use another application to listen to and/or purchase a recommended selection. At present, there exists no such mechanism for discovering information related to digital media content in view of social networking relationships that is presented in a visual and intuitive manner.

### SUMMARY

Accordingly, various embodiments related to facilitating the discovery of media content are disclosed. For example, one disclosed embodiment provides a computing device configured to perform a method displaying information related to media items in a graphical user interface. The method includes displaying one or more available media items in a view of the graphical user interface, and displaying a control operable to display an exploratory overlay related to a media item. The method further includes receiving via the graphical user interface a user selection of the control for a selected media item, and in response, displaying the exploratory overlay, the exploratory overlay comprising a visual representation of the selected media item and visual representations of a plurality of related media items that are related to the selected media item. The method further comprises transforming a display state of the exploratory overlay based on a user interaction with the exploratory overlay

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram of an embodiment of a computing system.

FIG. 2 is a flow diagram of an embodiment of a method for displaying information related to media items in a graphical user interface.

FIG. 3 is a screen view of an embodiment of a graphical user interface showing a detailed view of a selected media item.

FIG. 4 is a screen view of an embodiment of a graphical user interface showing an artist type media item in an exploratory overlay.

FIG. 5 is a screen view of an embodiment of a graphical user interface showing animation of a selected media item in the exploratory overlay of FIG. 4.

FIG. 6 is a screen view of an embodiment of a graphical user interface showing animation of media items as they appear in the exploratory overlay of FIG. 4.

FIG. 7 is a screen view of an embodiment of a graphical user interface showing collective animation of all media items upon display in the exploratory overlay of FIG. 4.

FIG. 8 is a screen view of an embodiment of a graphical user interface showing user interaction with an album type media item in the exploratory overlay of FIG. 4.

FIG. 9 is a screen view of an embodiment of a graphical user interface showing a selected user type media item in the exploratory overlay of FIG. 4.

### DETAILED DESCRIPTION

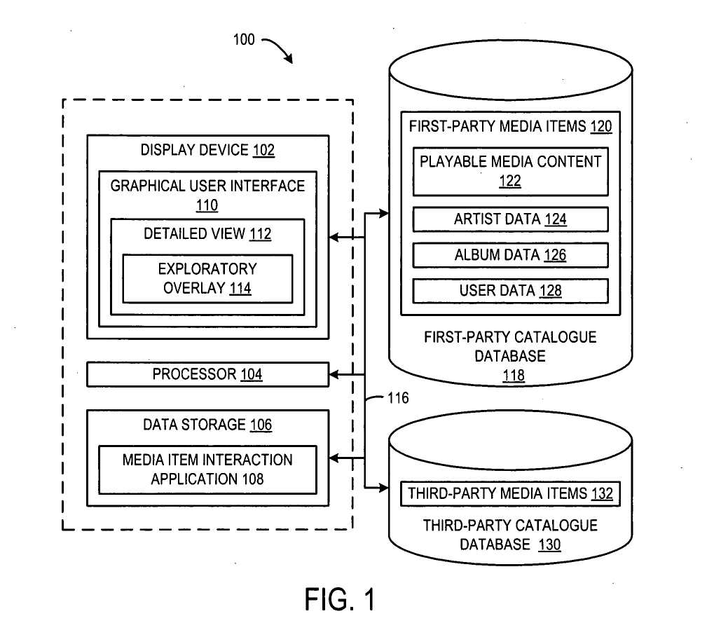

FIG. 1 illustrates an embodiment of a computing system 100 in which a user may interact with media items. More particularly, computing system 100 may be configured to present media items in a visual manner that exposes relationships between different media items. Computing system 100 comprises a display device 102, a processor 104, and data storage 106 operatively coupled via communication subsystem 116. Communication subsystem 116 may comprise local communication connections such as a communication bus, direct connections, etc. Further, communication subsystem 116 may comprise remote connections such as a wired or wireless network connection (e.g., local area network, wide area network, etc.). Media item interaction application 108 may be at least partially stored on data storage 106 and executed by processor 104. Data storage 106 may be virtually any suitable computer-readable medium such as non-volatile or volatile memory, hard disk, optical storage disk, etc.

Media item interaction application 108 may be configured to generate a graphical user interface (GUI) 110 that may be presented by display device 102. A user may interact with GUI 110 to discover information related to various media items displayed in GUI 110. More particularly, a user may provide user input via GUI 110 that transforms the display state of GUI 110 to reveal information related to various media items. In particular, media item interaction application 108 may be configured to display, in GUI 110, representations of one or more available media items, wherein the term “available” indicates that the represented media items are accessible by the user. In some embodiments, a plurality of media items may be organized according to various media item types. In one example, the plurality of media items are associated with music and organized into a catalogue of different types of media items that include musical artists, musical albums, and users of an online entertainment service. Other non-limiting examples of media item types may include music videos, television shows, episodes, channels, networks, video games, movies, actors, directors, etc. Graphical user interface 110 may be configured to enable a user to make a selection of a selected media item from a plurality of available media items that invokes a detailed view 112 of the selected media item to be displayed in GUI 110. Detailed view 112 may comprise information related to the selected media item.

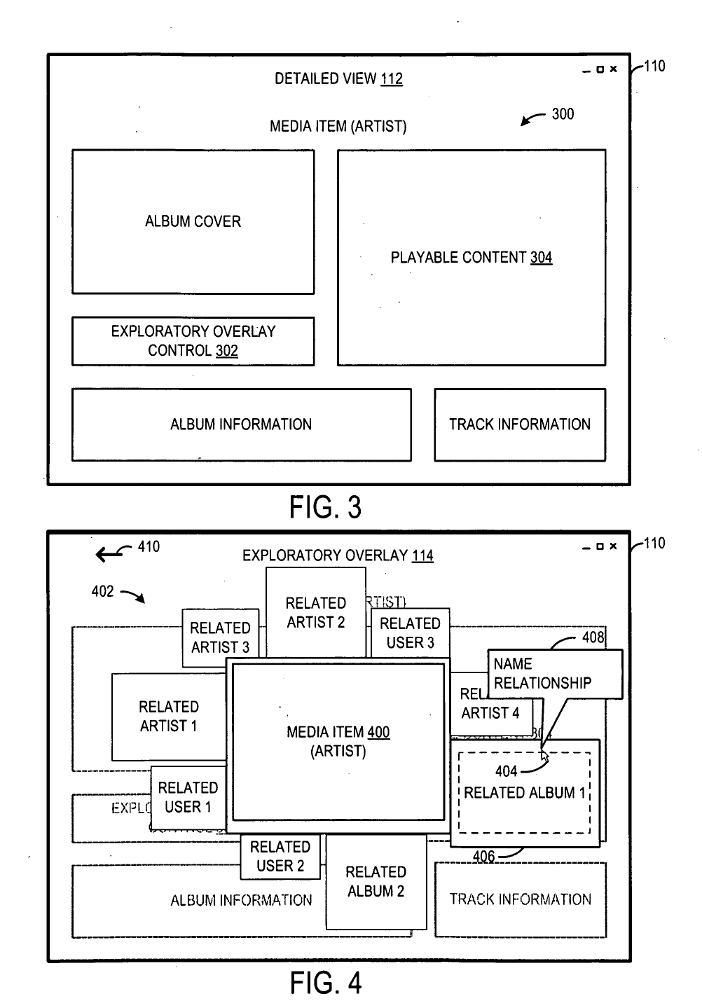

Media item interaction application 108 may be configured to display, in GUI 110, a control operable by a user to display an exploratory overlay 114 over detailed view 112 (among other views displayed in the GUI) for a selected media item. Exploratory overlay 114, in one example embodiment, may comprise a centrally located visual representation of the selected media item as well as peripherally located visual representations of media items related to the selected media item. The display state of exploratory overlay 114 may be transformed by user interaction via GUI 110. Transformation of the display state of the exploratory overlay will be discussed in further detail below with reference to FIGS. 3-9. In other embodiments, the selected media item and related media items may be displayed in other suitable layouts.

The visual representations of the media items displayed in exploratory overlay 114 may comprise any suitable depiction. For example, the visual representations may be image tiles. Revisiting the music example discussed above, the visual representations may include images of musical artists, album cover art, and user created images. Further, the media items may be related through different relationship types. Example relationship types may include a related album, a related artist, an influencer, influenced by, friend of, top listener, friend listener, recently played, top played, favorite artist, and favorite album.

Media items that are related to the selected media item may be chosen to populate exploratory overlay 114 in any suitable manner. In one example, a list of related media items may be created that ranks the related media items based on a relationship strength algorithm between the selected media item and the related media item. A plurality of related media items may be selected from the list to populate exploratory overlay 114 based on various selection criteria. For example, the highest ranked media items may be selected. As another example, the highest ranked media items of each media item type may be selected. As yet another example, the highest ranked media items of different relationship types may be selected. As still yet another example, the related media items may be selected randomly from the list. In some cases, media items that have a relationship strength above a threshold relationship strength may be selected. It will be appreciated that media items may be chosen for display in exploratory overlay 114 based on criteria other than relationship strength. In some cases, media items in the list may be excluded from selection to be displayed in exploratory overlay 114. For example, different versions of a media item may be excluded from selection. In one particular example, karaoke versions of a musical album are excluded from selection.

Continuing with FIG. 1, media item interaction application 108 may be operatively coupled with first-party catalogue database 118 and/or third-party catalogue database 130 via communication subsystem 116. First-party catalogue database 118 may be directly associated with media item interaction application 108. That is, first-party catalogue database 118 may comprise first-party media items 120, and more particularly playable media content (e.g., music/video/image files) 122 that may be executed (i.e., played) by a user via media item interaction application 108. First-party media items 120 may further comprise artist data 124, album data 126, and user data 128 that may be used to provide information to a user via GUI 110 to facilitate discovery of various media items.

Like first-party catalogue database 118, third-party catalogue database 130 may comprise third-party media items 132 that may be presented via GUI 110 to facilitate discovery of and interaction with various media items. However, third-party catalogue database 130 is not associated with media item interaction application 108. Thus, in some cases, for any variety of reasons (e.g., no license, does not meet standards, etc.), third-party media items 132 do not comprise playable media content. As such, third-party media items 132 may be provided to supplement media item information (e.g., artist information, album information, etc.) presented to a user to facilitate discovery of various media items.

It will be appreciated that a media item may exist in both first-party catalogue database 118 and the third-party catalogue database 130. In some embodiments, first-party catalogue database 118 and/or the third-party catalogue database 130 may be stored locally in local data storage 106, while in other embodiments, first-party catalogue database 118 and/or third-party catalogue database 130 may be stored remotely, such as across a network.

Media item interaction application 108 may receive media items and associated information for use in detailed view 112 and exploratory overlay 114 from first-party catalogue database 118 and third-party catalogue database 130. For example, the associated information may be used to create a list of media items that are related to a media item selected for display in exploratory overlay 114. The list may include media items in first-party catalogue database 118 and media items in third-party media item catalogue database 130. The media items may be ranked according to a relationship strength with the selected media item. Further, a plurality of media items may be selected to populate exploratory overlay 114 based on their relationship strength with the selected media item. In some embodiments, media items provided from first-party database 118 may be weighted to have a higher relationship strength than media items provided from the third-party catalogue database 130 so that content from the associated catalogue may be featured over third-party content.

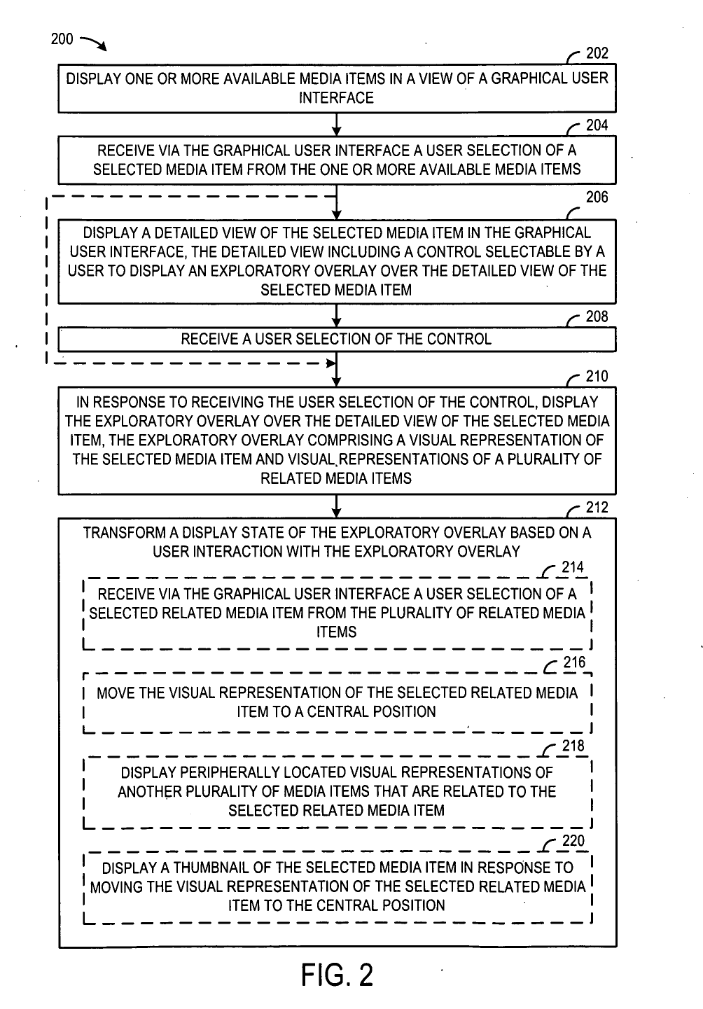

FIG. 2 illustrates an embodiment of a method 200 for displaying information related to media items in a graphical user interface. Method 200 first comprises, at 202, displaying one or more available media items in a view of the graphical user interface. The media items may be organized according to different media item types, such as artist types, album types, and user types, for example. At 204, the method may comprise receiving via the graphical user interface, a user selection of a selected media item from the one or more available media items.

At 206, the method may comprise displaying a detailed view of the selected media item in the graphical user interface. The detailed view may comprise a control operable by a user to display an exploratory overlay over the detailed view of the selected media item. In some embodiments, the control may be displayed in views other than the detailed view of the selected media item and may be operable to display the exploratory overlay. For example, the control may be displayed in a collection or gallery view, a marketplace view, a social view, and/or a now playing view of the graphical user interface. At 208, the method may comprise receiving via the graphical user interface a user selection of the control.

At 210, the method may comprise, in response to receiving the user selection of the control, displaying an exploratory overlay over the detailed view of the selected media item. The exploratory overlay may comprise a centrally located visual representation of the selected media item and peripherally located visual representations of a plurality of related media items related to the selected media item. One or more of the related media items may be of a different media item type than the selected media item. For example, where a musical artist is selected for presentation in the exploratory overlay, a visual representation of the selected musical artist may be positioned centrally in the exploratory overlay and visual representations of related artists, albums, and/or user may be presented peripherally around the visual representation of the selected media artist in the exploratory overlay.

In some embodiments, the exploratory overlay may be displayed in response to the selection of the selected media item from the one or more available media items (represented by the dashed line from 204 to 210). In this case, the detailed view of the selected media item may not displayed in some cases, and instead the exploratory overlay may be displayed over the view of the one or more available media items. Further, in some embodiments, the exploratory overlay may be displayed in response to a user selection to play a track (e.g., song) associated with a specified media item. Further, such a selection may cause a different view to be displayed (e.g. a now playing view) and the exploratory overlay may be displayed over that different view. In these embodiments, the control comprises each selectable media item in the one or more available media items.

At 212, the method may comprise transforming a display state of the exploratory overlay based on a user interaction with the exploratory overlay. A user may interact with the exploratory overlay in a variety of ways to effect different transformations. For example, as indicated at 214, the method may comprise receiving via the graphical user interface a user selection of a selected related media item from the plurality of related media items for discovery. At 216, the method may comprise, in response to receiving the user selection of the selected related media item, transforming a display state of the exploratory overlay by moving the visual representation of the selected related media item to a central position of the exploratory overlay. At 218, the method may include displaying peripherally located visual representations of another plurality of media items that are related to the selected related media item. At 220, the method may include, in response to moving the visual representation of the selected related media item to the central position, displaying a thumbnail of the selected media item in a “history” portion of the user interfaced so that the user can quickly view and locate previously discovered media items. Additional examples of user interaction and associated transformations of the exploratory overlay will be discussed in further detail below with reference to FIGS. 3-9.

The above described method may be performed to bring together correlated media items across different types of relationships into a single view to facilitate user interaction that promotes discovery of different related media items. Moreover, by using visual representations of media item arranged in a contextual overlay, the relationships between media items may be easily realized through visualization.

It will be appreciated that part or all of the above described method may be implemented as instructions stored in data storage 106 and executed by processor 104 of FIG. 1.

FIGS. 3-9 are screen views of GUI 110 of FIG. 1 that show an example sequence of user interactions and corresponding display state transformations. FIG. 3 illustrates an example display state of detailed view 112 of a media item selected from a plurality of available media items by a user via GUI 110. Detailed view 112 comprises media item information 300 related to the selected media item. In the illustrated example, the selected media item is a musical artist. Accordingly, media item information 300 comprises information about albums created by the musical artist, album cover art, and tracks or songs on the albums. Detailed view 112 may comprise playable content 304 that may be executed based on a user selection via GUI 110. For example, playable content 304 may include music files and/or video files that may be executed (or played) by media item interaction application 108 based on a user selection of specified file of playable content 304. Further, detailed view 112 may comprise control 302 that may be selectable by a user via GUI 110 to display exploratory overlay 114 over detailed view 112 of the selected media item.

FIG. 4 illustrates an example display state of exploratory overlay 114 that may be displayed in response to receiving a user selection of control 302. Exploratory overlay 114 may comprise a visual representation of the selected media item 400 and visual representations of a plurality of related media items 402 that are related to the selected media item. Visual representation of the selected media item 400 may be centrally positioned and sized larger than visual representations of the plurality of related media items 402 to indicate that visual representation of the selected media item 400 is the seed or selected media item. Further, visual representations of the plurality of related media items 402 may be peripherally positioned around visual representation of the selected media item 400 to indicate that they are related to the selected media item.

One or more of the plurality of related media items that correspond to visual representations 402 may be of a media item type different than the media item type of the selected media item. For example, visual representations of the plurality of related media items 402 may correspond to artists, albums, and/or users having some type of relationship with the selected artist. Furthermore, since an artist type media item is featured, relationship types of media items that are related to the artist may include related albums, related artists, followers of artist, influencers of artist, other albums by artist, friend listeners, and top listeners.

As discussed above, the plurality of related media items may be selected to populate exploratory overlay 114 according to a variety of different methods. In one example related media items are selected based on relationship strength with the selected media item. The relative size and position of visual representations of the plurality of related media items 402 are based on relationship strength. For example, a round robin approach may be used to populate the exploratory overlay where a media item having the highest relationship from each media item type or relationship type may be selected and the relative size of the visual representation may correspond to the order of selection (e.g., first media item selected is largest, second media item selected is second largest, and so on).

User interaction via GUI 110 may transform the display state of exploratory overlay 114. In one example, a user interacts with exploratory overlay 114 via user input cursor 404. In the illustrated embodiment, user input cursor 404 may roll over a visual representation of a selected related media item (i.e., related album 1) 406 to transform the display state of the visual representation of the selected related media item. In particular, when user input cursor 404 rolls over the visual representation of the selected related media item 406, the visual representation may become animated to temporarily grow in size as indicated by solid lines (the originally sized and positioned visual representation is indicated by dashed lines). Animating the growth may highlight the visual representation to draw the user's attention to the selected related media item to promote further discovery. Furthermore, when user input cursor 404 rolls over the visual representation of the selected related media item 406, a dialogue box 408 may be displayed. Dialogue box 408 may comprise a name of the selected related media item and a relationship type with the selected media item.

Exploratory overlay 114 may be transparent so that detailed view 112 is at least partially visible through the exploratory overlay. The ability for a user to view detailed view 112 while interacting with exploratory overlay 114 may allow a user to be visually reminded of the originally selected media item while discovering other media items. Furthermore, exploratory overlay 114 may comprise a back selector 410 that may be configured to transform a display state of GUI 110 to a previous display state. In the illustrated embodiment, selection of back selector 410 would cause detailed view 112 to be displayed by GUI 110. Back selector 410 may permit a user to retrace their steps to view previously selected media items during discovery of other media items.

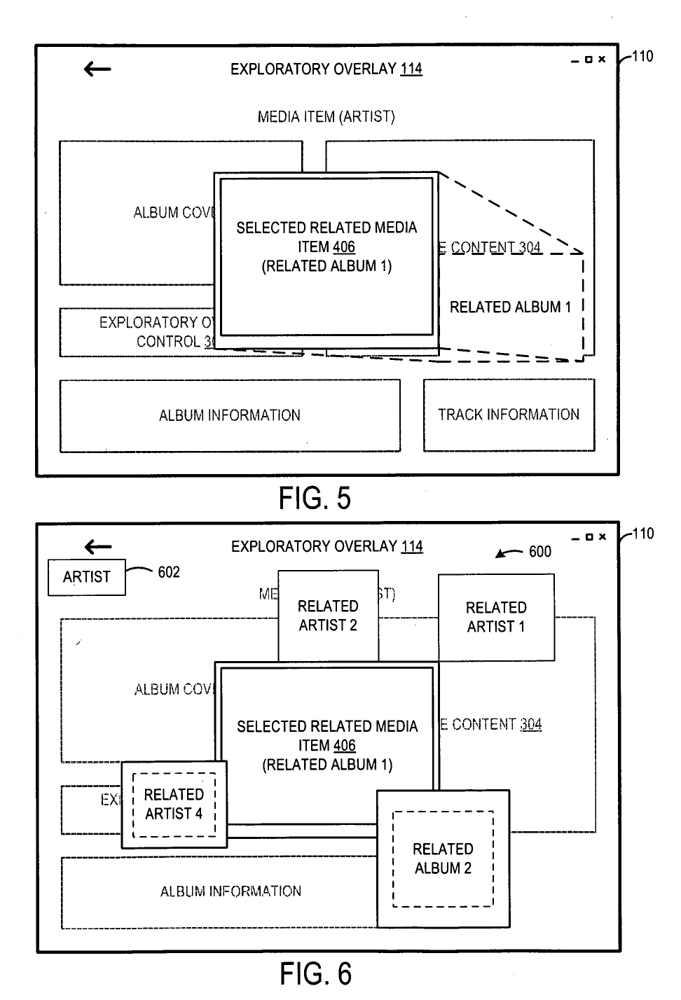

FIG. 5 illustrates an example display state of exploratory overlay 114 that may be displayed in response to user selection of the visual representation of the selected related media item 406. In particular, the illustrated display state is transformed from the display state shown in FIG. 4 by removing all visual representations of the media items except for the visual representation of the selected related media item 406 and moving the visual representation of the selected related media item 406 to a central position of exploratory overlay 114. In some embodiments, visual representations of related media items that are removed from display may be animated to appear as moving off-screen. The transition between display states may be animated. In particular, movement of the visual representation of the selected related media item 406 from the peripheral position to the central position may be animated to capture the user's attention and promote further discovery of the media item. The size and position of the visual representation of the selected related media item 406 prior to selection is indicated by dashed lines.

FIG. 6 illustrates an example display state of exploratory overlay 114 that may be displayed after the visual representation of the selected related media item 406 has been moved to the center position. At this point, exploratory overlay 114 may be re-populated with visual representations of another plurality of media items 600 related to selected related media item 406. The selected related media items may be of different media item types. Further, the media items may be different from the media items related to the selected media item that was previously displayed.

Each visual representation of the plurality of media items 600 may be animated to temporarily grow in appearance in response to appearing in exploratory overlay 114 of GUI 110. Moreover, during animation, each visual representation may be temporarily displayed in front of the selected related media item. For example, the media items, related artist 4 and related album 2, have a relationship with related album 1 and have been selected to populate exploratory overlay 114. As shown, the visual representations of related artist 4 and related album 2 have just appeared in exploratory overlay 114, and thus are animated to temporarily grow in size as indicated by the solid lines. The actual size of the visual representations is indicated by the dashed lines. The visual representations are animated to grow in size upon appearing in exploratory overlay 114 to divert the user's attention to the related media items. As such, the related media items may be highlighted to promote discovery by a user.

The display state of exploratory overlay 114 may be transformed further upon the visual representation of the selected related media item 406 moving to the center position by a media item tracking thumbnail 602 being displayed in exploratory overlay 114. Media item tracking thumbnail 602 may be positioned peripherally in exploratory overlay 114 so as to not draw too much attention from other media items. Media item tracking thumbnail 602 may be displayed to act as a visual reminder of a previously selected media item, and thereby to display a history of previously-discovered items. In the illustrated case, media tracking thumbnail 602 provides a visual reminder of selected media item 400. Media item tracking thumbnail 602 may be selected to return to the previous display state where that media item is featured with associated related media items. As related media items are selected for discovery and the display state of exploratory overlay 114 is repeatedly transformed, additional media item tracking thumbnails may be displayed in the order of media items selected. Accordingly, a list of previously discovered media items may be tracked so that a user may easily revisit them as desired.

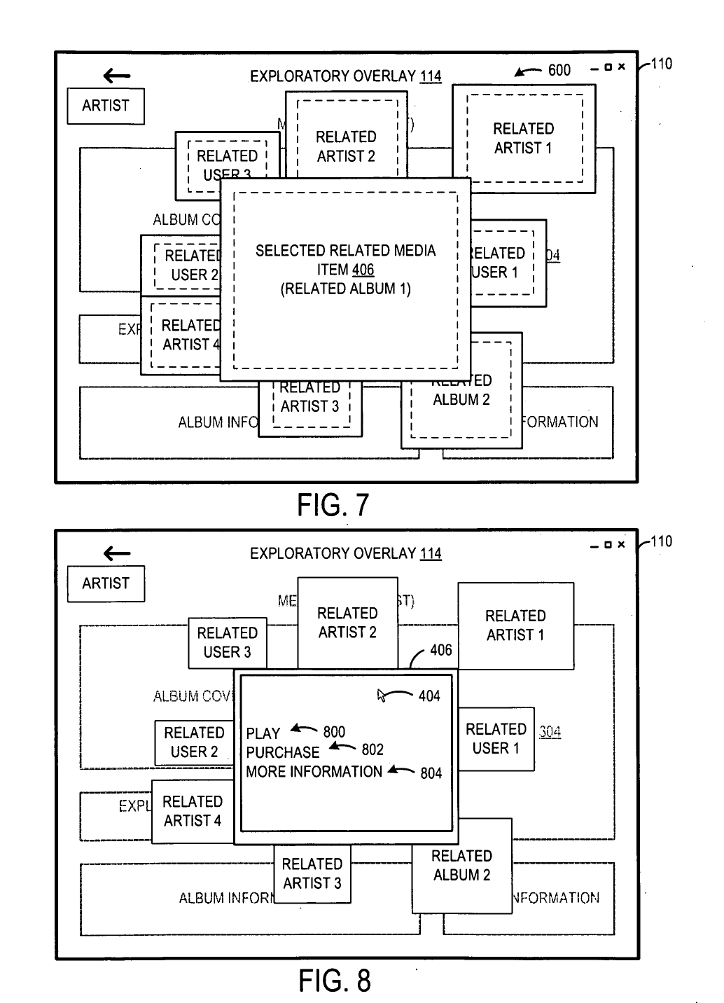

FIG. 7 illustrates an example display state of exploratory overlay 114 that may be displayed after all visual representations of the plurality of media items 600 related to selected related media item 406 have appeared in exploratory overlay 114. At this point, all visual representations of the media items are collectively animated to temporarily grow in appearance upon initial display in exploratory overlay 114 of GUI 110. The animation indicates that the display state has transitioned from featuring the selected media item (i.e., the artist) to featuring the selected related media item (i.e., related album 1) and that media items related to the selected related media item have been selected and displayed. Since an album type media item is featured, relationship types of media items that are related to the album may include related albums, related artists, followers of artist, influencers of artist, other albums by artist, friend listeners, and top listeners.

FIG. 8 illustrates an example display state of exploratory overlay 114 where user input cursor 404 rolls over the centrally located visual representation of the selected related media item 406. The interaction of user input cursor 404 with the visual representation of the selected related media item 406 may cause one or more of a play selector 800, a purchase selector 802, and a more information selector 804 to be displayed. The play selector 800, purchase selector 802, and more information selector 804 may be presented in visual representation of the selected related media item 406. Upon selection of play selector 800, a sample of tracks (or full tracks) may be played. Upon selection of purchase selector 802, the album or specified tracks may be downloaded or added to a shopping cart for purchase via media item interaction application 108. Upon selection of more information selector 804, additional information related to the selected media item may be displayed. The play selector 800, purchase selector 802, and more information selector 804 may be displayed for as long as user input cursor 404 is on visual representation of the selected related media item 406 or until one of the selectors is selected.

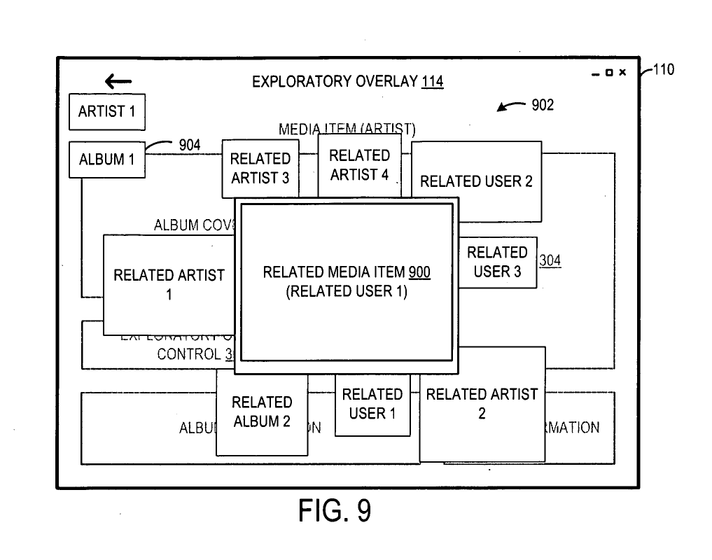

FIG. 9 illustrates an example display state of exploratory overlay 114 that may be displayed in response to receiving a user selection of another related media item that is related to the selected related media item. In this example, a user type media item 900 is selected. Upon selection, the visual representation of the user type media item 900 may be animated to be centrally located and exploratory overlay 114 may be populated with peripherally located visual representations of media items 902 related to the user type media item 900. Since a user type media item is featured, relationship types of related media items 902 that are related to user type media item 900 may include recent played album, recent played artist, top played artist, favorite artist, favorite album, and friend of user. The incorporation of social users as user type media items in GUI 110 and more particularly exploratory overlay 114 may enable discovery of media items through social connections. In other words, these social connections may bring together users with similar likings who may have a greater probability of finding media items shared amongst each other to be favorable which further promotes discovery.

Furthermore, a media item tracking thumbnail 904 of the selected related media item (e.g., related album 1) is displayed in response to the visual representation of user type media item 900 moving to the center position. Media item tracking thumbnail 904 may act as a visual reminder of the previously selected media item. Media item tracking thumbnail 904 may be selected to display the previously selected related media item 406 and related media items 600.

In some embodiments, the visual layout of the exploratory overlay may differ from the layout that includes the centrally positioned visual representation of the selected media item and the peripherally positioned visual representations of the media items related to the selected media item. Instead, for example, a tree type visual layout may be employed where the selected media item is the root from which related items branch off according to media item type and relationship type.

It will be appreciated that each time a media item is selected or refreshed other than from selection of a media item tracking thumbnail or the back selector, the exploratory overlay may be repopulated with a different set of related media items to further promote discovery of different media items. The repopulation may be performed randomly. Consequently, the different set of related media items may include previously displayed related media items.

In some embodiments, the display state of exploratory overlay may be transformed automatically without user interaction based on different trigger events. For example, the display state of the exploratory overlay may be transformed after a predefined duration. In one particular example, the display state of the exploratory overlay is transformed after thirty seconds have elapsed without user interaction with the exploratory overlay. In one embodiment, the transformation of the display state may include updating one of the visual representations of the related media items with a new related media item selected at random. The display state continues to be transformed by displaying a visual representation of a randomly selected related media item after every twenty second duration without user interaction.

As another example, the display state of the exploratory overlay is transformed in response to different tracks being played. Accordingly, when one track ends and/or is switched to another track, the display state transforms to display a visual representation associated with the currently playing track in the central position of the exploratory. In other words, the display state of the exploratory overlay transforms to keep up with the track that is currently playing. In some cases, the display state may be selectively transformed based on whether or not a user is interaction with the exploratory overlay.

It will be appreciated that the computing devices described herein may be any suitable computing device configured to execute the programs described herein. For example, the computing devices may be a mainframe computer, personal computer, laptop computer, portable data assistant (PDA), gaming console, computer-enabled wireless telephone, networked computing device, or other suitable computing device, and may be connected to each other via computer networks, such as the Internet. These computing devices typically comprise a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

Furthermore, in some embodiments, the above described software programs may be implemented on a server computing system that serves data to requesting client computing devices. For example, the media item interaction application may be implemented as a “web application” accessible at a website via the Internet.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A computing device, comprising:
a processor; and
data storage containing instructions stored thereon executable by the processor to:
display a view of one or more available media items on a graphical user interface;
display a control operable by a user to display an exploratory overlay related to a media item selectable by the user;
receive a user input selecting the control for a selected media item;
in response, display the exploratory overlay, the exploratory overlay comprising a visual representation of the selected media item and visual representations of a plurality of related media items that are related to the selected media item; and
transform a display state of the exploratory overlay based on a user interaction with the exploratory overlay.

2. The computing device of claim 1, wherein the control comprises each media item displayed in the view of the one or more media items, and wherein user selection of the selected media item from the view of one or more available media items prompts the display of the exploratory overlay.

3. The computing device of claim 1, wherein the control is displayed in a detailed view of the selected media item response to the user input selecting the selected media item.

4. The computing device of claim 1, wherein the plurality of related media items are selected from a list ordered according to a relationship strength with the selected media item.

5. The computing device of claim 4, wherein a relative size of the visual representation of each of the plurality of related media items corresponds to the relationship strength between the selected media item and that related media item.

6. The computing device of claim 1, wherein the user interaction comprises a user input cursor rolling over a visual representation of one of the plurality of related media items and transform comprises temporarily animating growth of the visual representation of one of the plurality of related media items.

7. The computing device of claim 6, wherein transform further comprises displaying a name and a relationship type of the one of the plurality of related media items in response to the user input cursor rolling over the visual representation of the one of the plurality of related media items.

8. The computing device of claim 1, wherein the view is at least partially visible through the exploratory overlay.

9. The computing device of claim 1, wherein the user interaction comprises a user input cursor rolling over the visual representation of the selected media item and transform comprises displaying one or more of a play selector, a purchase selector, and a more information selector for the selected media item.

10. The computing device of claim 1, wherein the control is displayable in one or more of a collection view, a marketplace view, a social view, and a now playing view of the graphical user interface.

11. The computing device of claim 1, wherein selected media item comprises an artist, an album, or a user, and wherein each of the plurality of related media items are of a relationship type selected from a related album, a related artist, an influencer, influenced by, friend of, top listener, friend listener, recently played, top played, favorite artist, and favorite album.

12. A method for displaying information related to media items in a graphical user interface, the method comprising:
displaying a view of a selected media item on the graphical user interface, the view of the selected media item comprising a control operable by a user to discover other media items related to the selected media item;
receiving via the graphical user interface a user selection of the control;
in response to receiving the user selection of the control, displaying a centrally located visual representation of the selected media item and peripherally located visual representations of a plurality of related media items that are related to the selected media item in the graphical user interface, wherein one or more of the related media items are of a different media item type than the selected media item;
receiving via the graphical user interface a user selection of a selected related media item from the plurality of related media items; and
in response to receiving the user selection of the selected related media item, transforming a display state of the graphical user interface by moving the visual representation of the selected related media item to a central position and displaying peripherally located visual representations of another plurality of related media items that are related to the selected related media item.

13. The method of claim 12, further comprising:
displaying a media item tracking thumbnail of the selected media item in response to moving the visual representation of the selected related media item to the central position.

14. The method of claim 12, wherein the related media items are selected based on a relationship strength with the selected media item, the related media items being selected from a collection of media items comprising media items in a media item catalogue associated with the graphical user interface and media items in a third-party media item catalogue.

15. The method of claim 14, wherein the relationship strength of the media items from the media item catalogue associated with the graphical user interface is higher than the relationship strength of the media items from the third-party media item catalogue.

16. The method of claim 15, wherein the related media items are selected randomly from a list of media items that have a relationship strength above a threshold relationship strength.

17. The method of claim 12, wherein each visual representation of a media item is animated to temporarily grow in appearance in response to appearing in the graphical user interface.

18. The method of claim 12, wherein all visual representations of media items are collectively animated to temporarily grow in appearance upon initial display on the graphical user interface.

19. Computer-readable data storage containing instructions stored thereon executable by a processor to:
display one or more available media items on a graphical user interface;
receive a user selection of a selected media from the one or more available media items via the graphical user interface;
in response to receiving the user selection of the selected media item, display a detailed view of the selected media item in the graphical user interface, the detailed view comprising a control operable by a user to display an exploratory overlay over the detailed view of the selected media item;
receive a user selection of the control via the graphical user interface;
in response to receiving the user selection of the control, display an exploratory overlay over the detailed view of the selected media item, the exploratory overlay comprising a centrally located visual representation of the selected media item and peripherally located visual representations of a plurality of related media items that are related to the selected media item, wherein one or more of the related media items are of a different media item type than the selected media item;
receive a user selection of a selected related media item via the graphical user interface; and
in response to receiving the user selection of the selected related media item, transform a display state of the exploratory overlay by moving the visual representation of the selected related media item to a central position of the exploratory overlay, and displaying peripherally located visual representations of another plurality of media items that are related to the selected related media item.

20. The computer-readable data storage of claim 19, further comprising instructions stored therein, that when executed by a processor:
display a media item tracking thumbnail of the selected media item in response to moving the visual representation of the selected related media item to the central position.
